(19) United States
(12) Patent Application Publication
(10) Pub. No.: US 2013/0294420 A1
(43) Pub. Date: Nov. 7, 2013

(54) METHOD AND APPARATUS FOR CONTROLLING ACCESS IN WIRELESS NETWORK

(71) Applicant: ELECTRONICS AND TELECOMMUNICATIONS RESEARCH INSTITUTE, Daejeon (KR)

(72) Inventors: Nam Seok KO, Daejeon (KR); Sung Kee NOH, Daejeon (KR); Sung Jin MOON, Daejeon (KR); Byung Ho YAE, Daejeon (KR); Tae-Soo CHUNG, Daejeon (KR); Woo-Sug JUNG, Daejeon (KR); Hwanjo HEO, Daejeon (KR); Jong Dae PARK, Daejeon (KR)

(73) Assignee: Electronics and Telecommunications Research Institute, Daejeon (KR)

(21) Appl. No.: 13/749,252

(22) Filed: Jan. 24, 2013

(30) Foreign Application Priority Data
May 4, 2012 (KR) 10-2012-0047695

(51) Int. Cl. H04W 72/04

(52) U.S. Cl. CPC H04W 72/0446
USPC 370/336

(57) ABSTRACT

In controlling channel access from a plurality of terminals in a wireless network, information for wireless resource allocation for each of the terminals is acquired, and channel access time for each terminal is determined based on the information for wireless resource allocation. Then, frames each containing the channel access time determined for each terminal are sequentially transmitted.

### CROSS-REFERENCE TO RELATED APPLICATION

This application claims priority to and the benefit of Korean Patent Application No. 10-2012-0047695 filed in the Korean Intellectual Property Office on May 4, 2012, the entire contents of which are incorporated herein by reference.

### BACKGROUND OF THE INVENTION

(a) Field of the Invention

The present invention relates to resource allocation, and more particularly, to a method and apparatus for controlling access by allocating resources in a wireless network.

(b) Description of the Related Art

In a wireless local area network (WLAN), a wireless terminal acquires the right of access to a shared WLAN depending on an access method based on CSMA/CA (carrier sense multiple access with collision avoidance). This basically results in a possibility of collision when each wireless terminal makes an access. Collision may occur when a plurality of terminals within an RF (radio frequency) transmission coverage area simultaneously uses one or multiple RF channels overlapping each other in order to transmit data.

Particularly, in one BSS (basic service set) including a plurality of terminals and an access point (AP), when a certain terminal A is transmitting data to the AP, there may exist a terminal B which is unable to physically detect a data transmission signal of the terminal A. When the terminal B and the terminal A simultaneously transmit data to the AP, the AP cannot properly receive all the data. This condition is referred to as the hidden node problem. To solve this problem, there was proposed the use of resources using a channel reservation protocol based on an RTS (request to send) frame and a CTS (clear to send) frame.

When transmitting data according to the channel reservation protocol based on the RTS frame and the CTS frame, a transmitting terminal firstly sends the RTS frame to a receiving terminal (or AP), and upon receiving the RTS frame, the receiving terminal (or AP) sends the transmitting terminal the CTS frame for approving a channel reservation if there is no previous channel reservation by other terminals. Even other terminals within the WLAN receive the above-described RTS frame and CTS frame, which are sent and received between terminals or between a terminal and an AP, and modify their NAV (network allocation vector) value. The NAV indicates the amount of time remaining for which an ongoing attempt for transmission cannot be made due to a channel reservation by other terminals. Accordingly, terminals other than the transmitting terminal and the receiving terminal, which successfully exchange the RTS frame and the CTS frame, delay a data transmission attempt until the NAV elapses, even if they cannot physically detect a data transmission signal properly due to the problem of a hidden node in a WLAN.

Even in a mixed environment of IEEE 802.11b and IEEE 802.11g, a terminal according to 802.11g is allowed to transmit the RTS frame and the CTS frame in the 802.11b mode, thereby protecting channel access for a terminal according to 802.11b.

However, the data transmission protocol based on a channel use request using the RTS frame and an approval of channel use from the CTS frame has the disadvantage of a decrease in overall traffic throughput due to basic overhead.

To further reduce such overhead, the transmitting terminal may send a CTS-to-self frame, rather than the RTs frame, before sending data to notify other terminals that the transmitting terminal itself will use the channel for a predetermined length of time, thereby preventing the other terminals having received the CTS frame from using the channel for its NAV time. This protocol is, however, disadvantageous in that the hidden node problem, which can be solved in the protocol of receiving the CTS frame from the AP after sending the RTs frame, cannot be solved.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for allowing more efficient wireless channel access in a wireless network.

An exemplary embodiment of the present invention provides an access control method which controls channel access from a plurality of terminals in a wireless network, the method including: acquiring information for wireless resource allocation to each of the terminals; determining channel access time for each terminal based on the information for wireless resource allocation; and sequentially transmitting frames each containing the channel access time determined for each terminal.

In the transmitting, a CTS (clear to send) frame containing the channel access time may be transmitted so that each terminal checks the channel access time granted to a given terminal. In the transmitting, the CTS frame may be transmitted, regardless of the reception of an RTS (request to send) frame from each of the terminals.

The transmitting may include, upon receiving data from the given terminal after transmitting the CTS frame, transmitting an ACK (acknowledge) frame to the terminal and then transmitting a CTS frame containing the channel access time for another terminal. The information for wireless resource information may be information for determining the timing and how long a shared wireless channel can be allocated to each terminal, and may include applications and application traffic characteristics of each terminal.

Another embodiment of the present invention provides an access control apparatus which controls channel access from a plurality of terminals in a wireless network, the apparatus including: a basic information acquisition unit that acquires information for wireless resource allocation to each of the terminals, the information for wireless resource allocation including applications and application traffic characteristics of each terminal; a channel allocation unit that determines channel access time for each terminal based on the information for wireless resource allocation; and a notification unit that sequentially transmits frames each containing the channel access time determined for each terminal.

The notification unit may transmit a CTS frame containing the channel access time, regardless of the reception of an RTS (request to send) frame from each of the terminals, so that each terminal checks the channel access time granted to a given terminal.

Such an access control device may be included in an access point, and the information for wireless resource allocation to each terminal may be provided from a WLAN controller for controlling the access point to control a connection to a wireless local network.

### BRIEF DESCRIPTION OF THE DRAWINGS

FIG. 1 is a view showing a procedure for access to a shared channel in a wireless network.

FIG. 2 is a view showing a CSMA/CA-based procedure for access to a shared channel in a wireless network.

FIG. 3 is a view showing a network environment to which a wireless channel access method is applied according to an exemplary embodiment of the present invention.

FIG. 4 is a view showing a structure of an access control apparatus according to an exemplary embodiment of the present invention.

FIG. 5 is a flowchart of a wireless channel access method according to an exemplary embodiment of the present invention.

FIG. 6 is a view showing a signal transmission and reception procedure using the wireless channel access method according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a method and apparatus for managing wireless resources according to an exemplary embodiment of the present invention will be described with reference to the drawings.

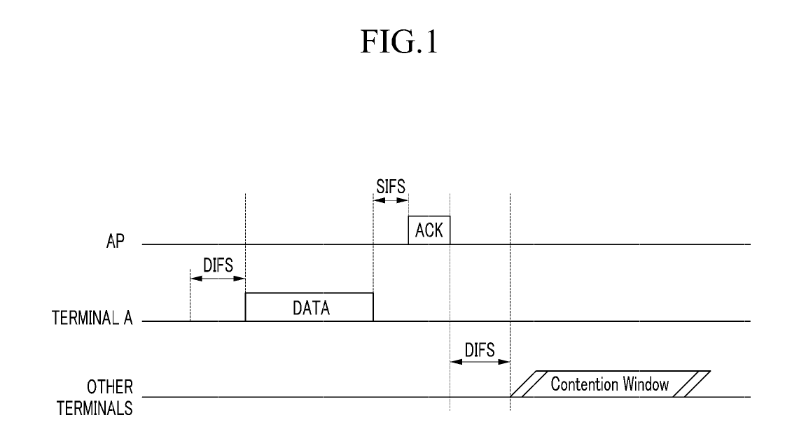

FIG. 1 is a view showing a procedure for access to a shared channel in a wireless network.

A procedure according to a method of accessing a shared channel without using an access protocol based on CSMA/CA (carrier sense multiple access with collision avoidance) is depicted. Here, a shared channel access method according to the 802.11 standard is illustrated.

As shown in the accompanying FIG. 1, a terminal A waits for DIFS (distributed inter frame space) time to send a packet to an access point AP, and then transmits data when it is allowed to use a shared channel. After receiving the data, the AP waits for a SIFS (short inter frame space) time, and then transmit ACK (acknowledge). Afterwards, the terminal A and other terminals wait for a DIFS time, and then attempt to access a shared channel.

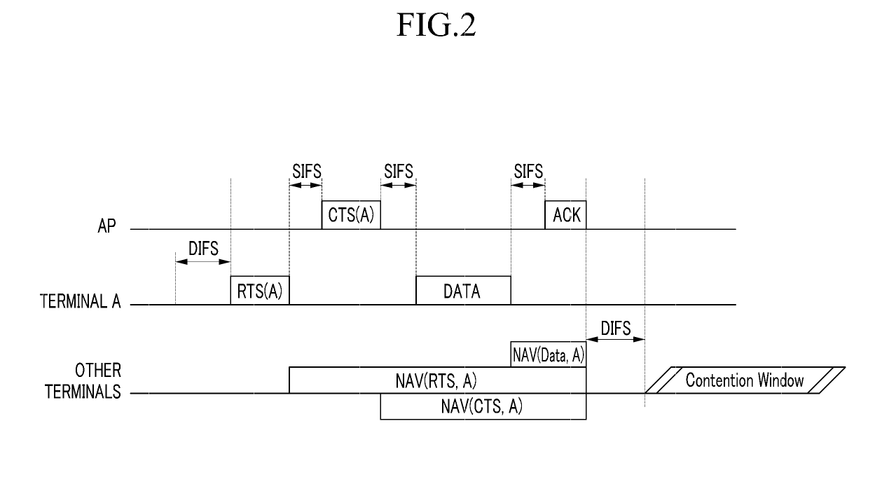

FIG. 2 is a view showing a CSMA/CA-based procedure for access to a shared channel in a wireless network. Here, access to the shared channel is made by using RTS/CTS (request to send)/(clear to send) frames.

As shown in the accompanying FIG. 2, a terminal A waits for DIFS (distributed inter frame space) time to send a packet to an access point AP, and then transmits an RTS frame for channel reservation when it is allowed to use a shared channel. After receiving the RTS frame, the AP waits for a SIFS time, and then allocates a channel to the terminal A by a CTS frame for a period of time requested by the RTS frame.

Upon receiving the CTS frame, the terminal A waits for a SIFS time, and then transmits data. After successfully receiving the transmitted data, the AP waits for a SIFS time, and then sends an ACK frame to the terminal A to notify the terminal A of successful data frame transmission.

Moreover, when the RTS frame is transmitted to the AP from the terminal A, the terminal A and other terminals write the time allocated to the terminal A in the RTS frame in their NAV (network allocation vector) and do not make a new transmission attempt during that time. The NAV value is updated by checking the CTS frame and the data frame sent from the terminal A, as well as the RTS frame, and checking the remaining time reserved for the terminal A. Afterwards, no RTS frame is received from a specific terminal, all the terminals including the terminal A wait for a DIFS time, and then attempt to access a shared channel.

When wirelessly accessing the shared channel, the overall traffic throughput may be decreased due to overhead.

In the exemplary embodiment of the present invention, an AP or WLAN controller finds out application traffic characteristics and operational policies of each terminal, and based on this information, the AP transmits a CTS frame to each terminal requiring wireless channel access control, thereby controlling wireless channel access from each terminal.

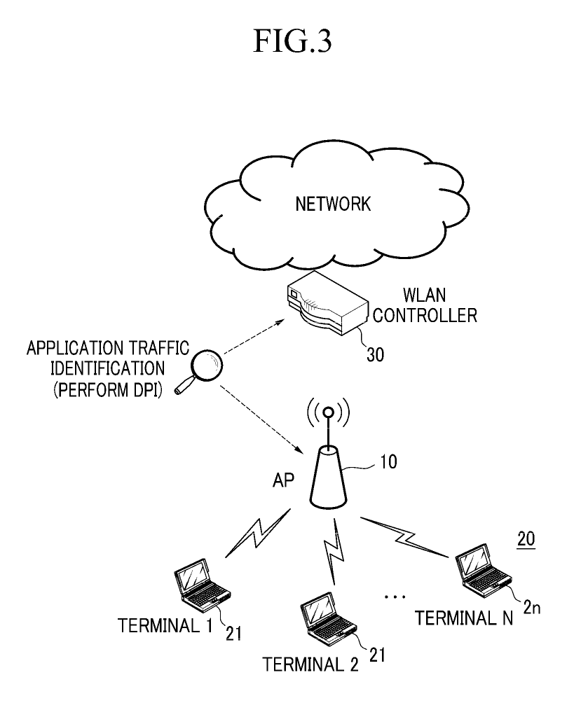

FIG. 3 is a view showing a network environment to which a wireless channel access method is applied according to an exemplary embodiment of the present invention.

As shown in the accompanying FIG. 3, a plurality of terminals 21, 22, . . . , 2n, (hereinafter collectively referred to as 20 for better comprehension and ease of description) access a wireless network through an AP 10, and a WLAN controller 30 communicates with the AP 10 to provide a network-based service to the terminal 20.

The AP 10 or WLAN controller 30 has information about the timing and how long a shared wireless channel can be allocated to each terminal, that is, information for wireless channel allocation.

The information for wireless channel allocation to each terminal can be acquired by a DPI (deep packet inspection) method or the like. The DPI method is to analyze an entire packet including IP header information such as the start address and destination address of the packet, which is an already well-known technology, and a detailed description thereof will be omitted. After the channel access procedure (e.g., see FIG. 1) using a shared channel contention protocol, the AP 10 or WLAN controller 30 checks for applications of each terminal 20 by using the DPI method or the like, and based on this, determines transmitted and received application traffic characteristics and operational policies. The determined information is used as information for wireless channel allocation to each terminal.

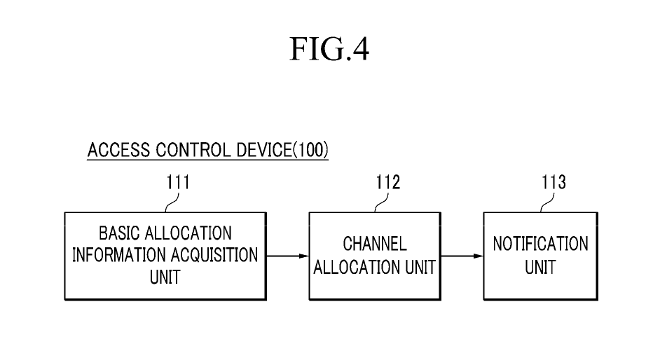

FIG. 4 is a view showing a structure of an access control apparatus according to an exemplary embodiment of the present invention.

As shown in FIG. 4, the access control apparatus 100 according to the exemplary embodiment of the present invention includes a basic allocation information acquisition unit 111, a channel allocation unit 112, and a notification unit 113.

The basic allocation information acquisition unit 111 acquires information for wireless channel allocation for each terminal wanting to access a shared channel. The information for wireless channel allocation includes applications, application traffic characteristics, operational policies, etc. of each terminal.

The channel allocation unit 112 determines channel access time based on information for wireless channel allocation acquired for each terminal.

The notification unit 113 notifies terminals of the channel access time allocated for each terminal. The notification unit 113 notifies each terminal of the allocated channel access time by a CTS frame. That is, an NAV (CTS, terminal ID) is included and transmitted in the CTS frame to notify a terminal having the terminal ID of the allocation of the channel access time corresponding to the NAV value.

The access control device 100 having this structure is implemented in such a way that it is included in the AP 10 to control wireless channel access from a terminal. In the case that the WLAN controller 30 manages the information for wireless channel allocation for each terminal, the access control device 100 can receive that information from the WLAN controller 30 and control channel access from a terminal.

Next, a wireless channel access method according to an exemplary embodiment of the present invention will be described.

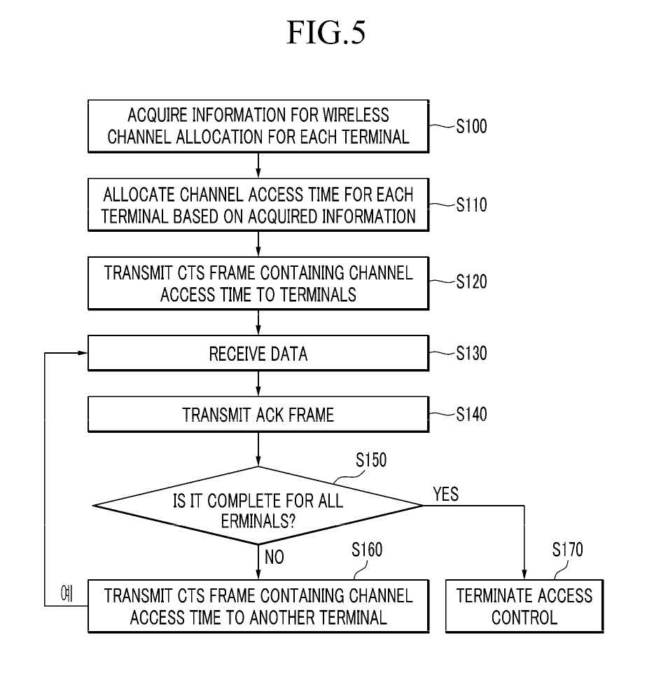

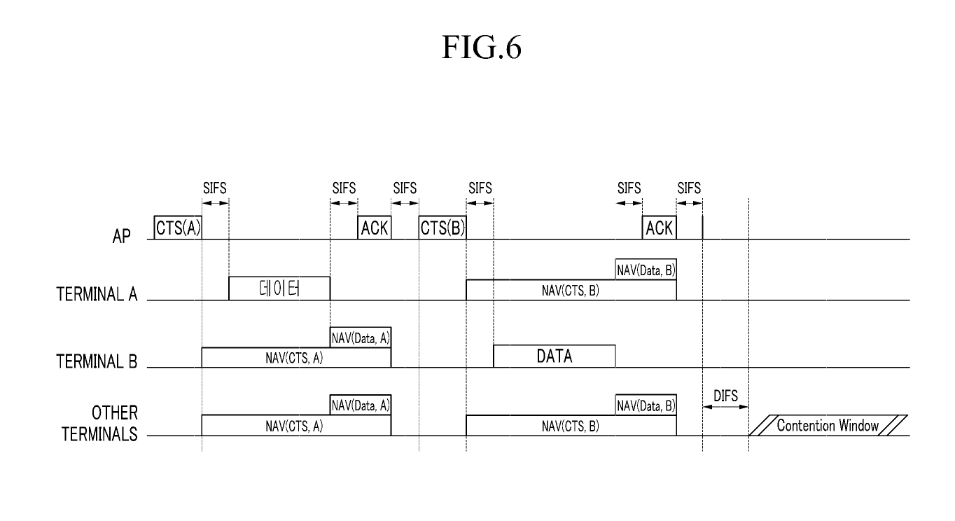

FIG. 5 is a flowchart of a wireless channel access method according to an exemplary embodiment of the present invention, and FIG. 6 is a view showing a signal transmission and reception procedure using the wireless channel access method according to the exemplary embodiment of the present invention.

In the exemplary embodiment of the present invention, the AP 10 or WLAN controller 30 has information about the timing and how long a shared wireless channel can be allocated to each terminal 20, that is, information for wireless channel allocation.

The AP 10 or WLAN controller 30 analyzes data packets that the terminal 20 transmits, as it is allowed to use a shared channel after waiting for a DIFS time according to the procedure shown in FIG. 1, and acquires information for wireless channel allocation.

In this way, after the information for wireless channel allocation is acquired, wireless channel access from terminals is controlled, as shown in FIG. 5. Hereinafter, an example will be described in which the access control device 100 included in the AP 10 controls channel access from terminals.

In controlling channel access from a plurality of terminals, e.g., a terminal A and a terminal B, that want to access a shared channel, information for wireless channel allocation for the terminal A and the terminal B is acquired (S100), and then the access control device 100 allocates the time required for the terminal A and the terminal B to transmit data, i.e., channel access time, based on the acquired information for wireless channel allocation (S110). Also, each terminal is notified of the allocated channel access time by a CTS frame.

The information for wireless channel allocation may be a bandwidth required by an application, a traffic pattern, or the like. Such information can be acquired by a variety of application identification methods, such as searching for a specific signature for a data payload or acknowledgment of a control message contained in a signaling message.

For example, on the assumption that the terminal A is detected as using a VoIP application requiring a 128 Kbps bandwidth as a result of the above-described application identification, channel access time is allocated to the terminal A in such a way as to support the 128 Kbps bandwidth. The channel access time can be determined as follows based on the 128 Kbps bandwidth information.

If it a packet byte used by an average VoIP application is a B1 byte, the time T1 required to transmit a B1 byte packet at 128 Kbps is calculated. If the average transmission rate of a given wireless channel is S1, the time T2 required to transmit a B1 byte at the S1 rate is calculated. In this case, the time T2 can be allocated to the terminal A every T1 period. Such a channel access time determination method can be modified in various ways depending on situations, including when a terminal uses a plurality of applications.

The access control device 100 allocates a channel for a period of channel access time determined based on the information for wireless channel allocation to the terminal A, and as shown in FIG. 6, transmits a NAV (CTS, A) containing a value corresponding to the allocated period of time by a CTS frame (S120). In this way, the access control device 100 transmits a CTS frame for the terminal A that has requested a channel reservation, and notifies all the terminals except the terminal A that the terminal A will occupy the channel during the time corresponding to the NAV (CTS, A). Accordingly, the other terminals including the terminal B become aware through the NAV (CTS, A) of the CTS frame that the terminal A will use the channel during a predetermined period of time corresponding to the NAV value.

After receiving the CTS frame, the terminal A waits for a SIFS time, and then transmits data (S130). Upon successfully receiving the data transmitted from the terminal A, the access control device 100 waits for a SIFS time, and then transmits an ACK frame to notify of successful data transmission (S140).

Afterwards, in order to permit wireless channel access from other terminals, the access control device 100 waits for a SIFS time to allow the terminal B to use a wireless channel, and then transmits a CTS frame for the terminal B to notify all the terminals except the terminal B that the terminal B will occupy the channel for a period of time corresponding to the NAV (CTS, B) (S150 and S160). That is, the access control device 100 transmits a CTS frame to the terminal A to notify of channel access permission, regardless of the reception of an RTS frame, in accordance with channel access times, which are determined without collision based on the information for wireless channel allocation acquired for each terminal, and thereafter transmits a CTS frame to the next terminal B to notify of channel access permission.

After receiving the CTS frame, the terminal B waits for a SIFS time, and then transmits data. After receiving data from the terminal B, the access control device 100 waits for a SIFS time, and then transmits an ACK frame to notify of successful data transmission.

Such a process is repeatedly performed on terminals requiring wireless channel access, and afterwards the access control device 100 terminates the above-described access control if an allocation for wireless channel access is not required for a specific terminal (S170). In this case, each terminal can attempt to make channel access after waiting for a DIFS time as shown in FIG. 1. Moreover, the above-described procedure can be repeatedly performed on the terminal A and the terminal B in such a manner that the AP periodically transmits a CTS frame to each of the terminals A and B at appropriate time intervals for wireless channel access.

As seen from the above, according to the exemplary embodiment of the present invention, the control access device sends a CTS frame to each terminal to directly control channel access from each terminal, based on information for wireless resource allocation, including an application traffic use pattern and characteristics of each terminal, which is determined by the AP or WLAN controller.

Accordingly, it is possible to prevent a decrease in overall traffic throughput due to overhead, as compared to when each terminal sends an RTS frame and receives a CTS frame. Moreover, appropriate channel access time can be allocated to each terminal, thus enabling efficient wireless channel access.

The exemplary embodiments of the present invention may also be implemented by a program realizing functions corresponding to the construction of the embodiment, and a recording medium on which the program is recorded, other than the apparatus and/or method described above. Such implementation may be easily made from the disclosure of the above embodiments by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An access control method which controls channel access from a plurality of terminals in a wireless network, the method comprising:
acquiring information for wireless resource allocation to each of the terminals;
determining channel access time for each terminal based on the information for wireless resource allocation; and
sequentially transmitting frames each containing the channel access time determined for each terminal.

2. The method of claim 1, wherein, in the transmitting, a CTS (clear to send) frame containing the channel access time is transmitted so that each terminal checks the channel access time granted to a given terminal.

3. The method of claim 2, wherein, in the transmitting, the CTS frame is transmitted, regardless of the reception of an RTS (request to send) frame from each of the terminals.

4. The method of claim 3, wherein, the transmitting comprises, upon receiving data from the given terminal after transmitting the CTS frame, transmitting an ACK (acknowledge) frame to the terminal and then transmitting a CTS frame containing the channel access time for another terminal.

5. The method of claim 1, wherein the information for wireless resource information is information for determining the timing and how long a shared wireless channel can be allocated to each terminal, and comprises applications and application traffic characteristics of each terminal.

6. The method of claim 2, wherein the information for wireless resource information is information for determining the timing and how long a shared wireless channel can be allocated to each terminal, and comprises applications and application traffic characteristics of each terminal.

7. The method of claim 3, wherein the information for wireless resource information is information for determining the timing and how long a shared wireless channel can be allocated to each terminal, and comprises applications and application traffic characteristics of each terminal.

8. The method of claim 4, wherein the information for wireless resource information is information for determining the timing and how long a shared wireless channel can be allocated to each terminal, and comprises applications and application traffic characteristics of each terminal.

9. An access control apparatus which controls channel access from a plurality of terminals in a wireless network, the apparatus comprising:
a basic information acquisition unit that acquires information for wireless resource allocation to each of the terminals, the information for wireless resource allocation including applications and application traffic characteristics of each terminal;
a channel allocation unit that determines channel access time for each terminal based on the information for wireless resource allocation; and
a notification unit that sequentially transmits frames each containing the channel access time determined for each terminal.

10. The apparatus of claim 9, wherein the notification unit transmits a CTS frame containing the channel access time, regardless of the reception of an RTS (request to send) frame from each of the terminals, so that each terminal checks the channel access time granted to a given terminal.

11. The apparatus of claim 10, wherein, upon receiving data from the given terminal after transmitting the CTS frame, the notification unit transmits an ACK (acknowledge) frame to the terminal and then transmits a CTS frame containing the channel access time for another terminal.

12. The apparatus of claim 9, wherein the access control device is included in an access point, and the information for wireless resource allocation to each terminal is provided from a WLAN controller for controlling the access point to control a connection to a wireless local network.
